(19) United States
(12) Patent Application Publication
(10) Pub. No.: US 2026/0326568 A1
(43) Pub. Date: Oct. 22, 2026

(54) Vehicle Dash Panel Assembly

(71) Applicant: ArcelorMittal, Luxembourg (LU)

(72) Inventors: Dan HASENPOUTH, Paris (FR); Joel WILSIUS, Paris (FR)

(21) Appl. No.: 19/106,755

(22) PCT Filed: Sep. 11, 2023
(86) PCT No.: PCT/IB2023/058981

§ 371 Date: Feb. 26, 2025

(30) Foreign Application Priority Data
Sep. 12, 2022 (WO) PCT/IB2022/058553

(51) Int. Cl. B60K 37/10; B62D 25/02; B62D 25/14

(52) U.S. Cl. CPC B60K 37/10; B62D 25/025; B62D 25/14

(57) ABSTRACT

Dash panel assembly for an automotive vehicle consisting of a lower dash panel and an upper dash panel, such that the lower and upper dash panels are each made by forming a single metallic sheet, the lower dash panel further includes a lower portion and an overlap portion, the upper dash panel further includes an upper portion and an overlap portion, once assembled to form the dash panel assembly, the lower and upper dash panel overlap each other in their respective overlap portion to form the overlap portion of the dash panel assembly and do not overlap each other in the lower portion of the lower dash panel and the upper portion of the upper dash panel.

The present invention relates to structural parts for an automotive vehicle and in particular to the dash panel assembly of a vehicle.

### BACKGROUND

Car makers are submitted to ever more demanding requirements. They are requested to increase the passive safety of vehicles and at the same time to reduce the vehicle weight in order to minimize greenhouse gas emissions for internal combustion engines or increase the vehicle's driving range for electric vehicles. At the same time, vehicle production costs must stay low and productivity rates high. Furthermore, car makers are looking to simplify vehicle production by lowering the number of separate individual parts making up a vehicle.

### SUMMARY OF THE INVENTION

The dash panel assembly separates the front motor compartment from the passenger compartment. It is a large assembly comprising several sub-parts, typically around ten individual sub-parts. It extends over the entire width of the vehicle and over a substantive portion in the elevation direction. It is involved in absorbing the crash energy and resisting intrusion in the case of a frontal crash or in the case of side impacts. It is an important structural element and one of the key passenger safety components. It also plays a significant role in ensuring the overall rigidity of the body in white.

The dash panel assembly is involved in improving the safety performance of the vehicle in various regulatory tests, such as for example:
the Insurance Institute for Highway Safety's (IIHS) Small Overlap Rigid Barrier (SORB) crash, in which a vehicle is impacted with only 25% overlap in the width by a rigid barrier moving at 64.4 km/h.
the IIHS's front overlap deformable barrier (ODB), in which a vehicle is impacted with only 40% overlap in the width by a rigid barrier moving at 64.4 km/h.
the US New Car Assessment Program's (USNCAP) pole tests, in which a vehicle having an initial lateral speed of 32.2 km/h impacts on its side a fixed pole.
the IIHS's side moveable deformable barrier (MDB) test, in which a vehicle is impacted on its side by a deformable barrier having a weight of 1500 kg and travelling at a speed of 50 km/h.

These tests themselves are becoming ever more stringent, with ever higher impact energy and stricter requirements.

It is an object of the present invention to provide a dash panel assembly having a very high crash management efficiency. It is also an object of the present invention to provide a vehicle with a dash panel assembly according to the invention.

It is also an object of the current invention to provide a dash panel assembly having a lower weight than current designs, thereby saving fuel in the case of combustion engines and increasing driving range in the case of electric engines driven vehicles.

Furthermore, it is an object of the present invention to address the challenges of increasing productivity, diminishing complexity and diminishing costs in vehicle production. Indeed, the current invention provides a dash panel assembly having fewer parts than the reference designs. The inventive design can be produced and assembled in very few manufacturing steps compared to the reference. On top of simplifying production, mitigating costs and increasing productivity, diminishing the number of production steps also diminishes the environmental footprint of the production process and diminishes overall CO2 emissions when manufacturing the vehicle.

The present invention provides a dash panel assembly for an automotive vehicle occupying the full transversal space of said automotive vehicle in between right and left side sill and in between right and left lower A-pillars, said dash panel assembly separating a front motor compartment from a passenger compartment and consisting of a lower dash panel and an upper dash panel, such that:
said lower and upper dash panels are each made by forming a single metallic sheet,
said lower dash panel further comprises a lower portion and an overlap portion,
said upper dash panel further comprises an upper portion and an overlap portion,
once assembled to form the dash panel assembly, the dash panel lower and upper overlap each other in their respective overlap portion to form an overlap portion of the dash panel assembly and do not overlap each other in the lower portion of the lower dash panel and the upper portion of the upper dash panel,
the overlap portion of the dash panel assembly comprises at least one flat overlap portion in which the lower and upper dash panels lay flat onto each other.

The present invention also provides an automotive vehicle comprising a dash panel assembly as described above.

In the following descriptions and claims, the directional terms are defined according to the usual directions of a mounted vehicle.

In particular, the terms “top”, “up”, “upper”, “above”, “bottom”, “low”, “lower”, “below” etc. are defined according to the elevation direction of a vehicle. The terms “front”, “back”, “rear”, “front”, “forward”, backward” etc. are defined according to the longitudinal direction of a vehicle, i.e. the direction in which the vehicle moves when following a straight line. The terms “left”, “right”, “transverse”, etc. are defined according to the orientation parallel to the width of the vehicle. The terms “inner”, “outer” are to be understood according to the width direction of the vehicle: the “inner” is closest to the central axis of the vehicle, i.e. closest to the inside of the vehicle, whereas the “outer” is located further away from said central axis of the vehicle, in effect closer to the outside of the vehicle. The same applies to the terms “distal” and “central”: the “distal” part is located closest to the outside of the vehicle and the “central” part closest to the center of the vehicle. The term “horizontal” refers to the orientation of the plane comprising the longitudinal and the transverse directions. The term “vertical” refers to any orientation comprising the elevation direction.

In the following figures, the orientations and spatial references are all made using an X, Y, Z coordinates referential, wherein Z is the elevation direction of the vehicle, X is the longitudinal direction of the vehicle and Y is the transverse direction of the vehicle. The referential is represented in each figure. When the figure is a 2D flat representation, the axis which is outside of the figure is represented by a dot in a circle when it is pointing towards the reader and by a cross in a circle when it is pointing away from the reader, following established conventions.

By “substantially parallel” or “substantially perpendicular” it is meant a direction which can deviate from the parallel or perpendicular direction by no more than 15°.

A steel sheet refers to a flat sheet of steel. It has a top and bottom face, which are also referred to as a top and bottom side or as a top and bottom surface. The distance between said faces is designated as the thickness of the sheet. The thickness can be measured for example using a micrometer, the spindle and anvil of which are placed on the top and bottom faces. In a similar way, the thickness can also be measured on a formed part.

By average thickness of a part, or of a portion of a part, it means the overall average thickness of the material making up the part after it has been formed into a 3-dimensional part from an initially flat sheet.

Tailor welded blanks are made by assembling together, for example by laser welding together, several sheets or cut-out blanks of steel, known as sub-blanks, in order to optimize the performance of the part in its different areas, to reduce overall part weight and to reduce overall part cost. The sub-blanks forming the tailor welded blanks can be assembled with or without overlap, for example they can be laser butt-welded (no overlap), or they can be spot-welded to one another (with overlap).

By opposition to a tailor welded blank, a monolithic blank refers to a blank which consists of one single sub-blank, without several sub-blanks being combined together.

A tailor rolled blank is a blank having multiple sheet thicknesses obtained by differential rolling during the steel sheet production process.

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The bending angle is measured according to the VDA-238 bending standard. For the same material, the bending angle depends on the thickness. For the sake of simplicity, the bending angle values of the current invention refer to a thickness of 1.5 mm. If the thickness is different than 1.5 mm, the bending angle value needs to be normalized to 1.5 mm by the following calculation where α1.5 is the bending angle normalized at 1.5 mm, t is the thickness, and αt is the bending angle for thickness t:

α1.5=(αt×√t)/√1.5

Hot stamping is a forming technology for steel which involves heating a blank of steel, or a preformed part made from a blank of steel, up to a temperature at which the microstructure of the steel has at least partially transformed to austenite, forming the blank or preformed part at high temperature by stamping it and simultaneously quenching the formed part to obtain a microstructure having a very high strength, possibly with an additional partitioning or tempering step in the heat treatment.

A multistep hot stamping process is a particular type of hot stamping process including at least one stamping step and consisting of at least two process steps performed at high temperature, above 300° C. For example, a multistep process can involve a first stamping operation and a subsequent hot trimming operation, so that the finished part, at the exit of the hot stamping process, does not need to be further trimmed. For example, a multistep process can involve several successive stamping steps in order to manufacture parts having more complex shapes than what can be realized using a single stamping operation. For example, the parts are automatically transferred from one operation to another in a multistep process, for example using a transfer press. For example, the parts stay in the same tool, which is a multipurpose tool that can perform the different operations, such as a first stamping and a subsequent in-tool trimming operation.

### BRIEF DESCRIPTION OF THE DRAWINGS

FIG. 1 is a perspective view of an automotive vehicle highlighting the location of the dash panel assembly.

FIG. 2 is a perspective view of a dash panel assembly and the parts surrounding it.

FIG. 3 is a perspective view of a dash panel assembly according to the state of the art—in this case the dash panel assembly is fully assembled.

FIG. 4 is a perspective view of a dash panel assembly according to the state of the art—in this case the different individual parts which are joined together to from the dash panel assembly have been offset from one another in order to represent each one clearly and separately.

FIG. 5 is a perspective view of an embodiment of a dash panel assembly according to the present invention—in this case the dash panel assembly is fully assembled.

FIG. 6 is a perspective view of an embodiment of a dash panel assembly according to the present invention—in this case the different individual parts which are joined together from the dash panel assembly have been offset from one another in order to represent each one clearly and separately.

FIG. 7A is a perspective view of the right-hand side of a dash panel assembly according to the present invention after having cut out the left-hand side of said dash panel according to the AA plane defined on FIG. 5.

FIG. 7B is a schematic cross section of a dash panel assembly according to the present invention according to the AA cross section direction defined on FIG. 5.

FIG. 8A is a schematic representation of an embodiment of a tailor welded blank used to manufacture an upper dash panel according to the present invention.

FIG. 8B is a schematic representation of an embodiment of a tailor welded blank used to manufacture a lower dash panel according to the present invention.

FIG. 9A is a perspective view of a simulated IIHS's front overlap deformable barrier (ODB) crash test at time t=0 s, i.e. just before the barrier impacts the vehicle. FIG. 9B represents the same thing but only the front motor and the dash panel assembly are shown in order to focus on the interaction between these two elements during the crash test.

FIGS. 10A, 10B and 11A, 11B are respectively showing the evolution of the previously described crash test simulation at t=0.085 s and t=0.105 s.

### DETAILED DESCRIPTION

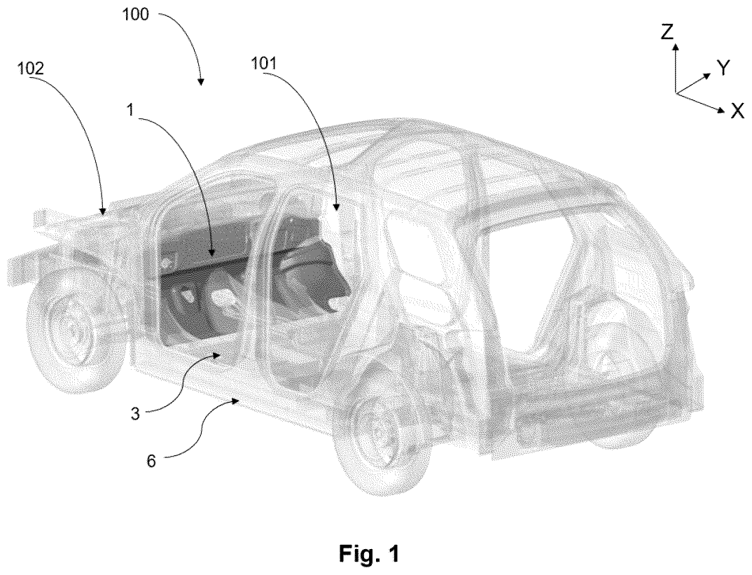

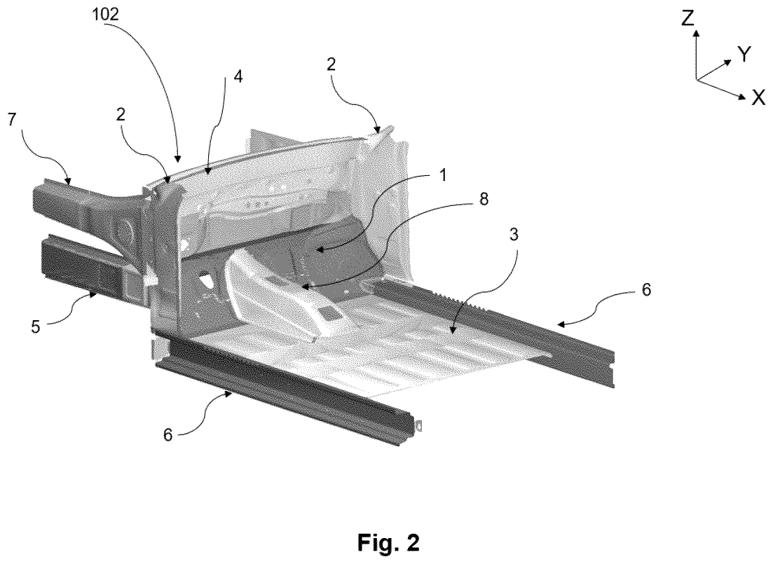

Referring to FIGS. 1 and 2, a passenger compartment 101 of an automotive vehicle 100 is the volume accessible to the occupants of the vehicle. A front motor compartment 102 of a vehicle 100 is the volume located in the front of the vehicle, extending transversally over the width of the vehicle and extending longitudinally between a front bumper up to the passenger compartment 101. While it is commonly referred to as the front motor compartment or the front engine compartment, in some vehicles an engine or motor can be located in a different location of the vehicle (e.g. in vehicles having the engine or motor in the back, in the center or directly attached to the wheels). It can in this case serve as a storage compartment, sometimes referred to as a “frunk”. It is usually closed by a hood on top.

For obvious safety reasons, said passenger compartment 101 needs to be protected in the case of a crash. The lower part of the passenger compartment is delimited by a floor panel 3, which extends transversally in between right and left side sills 6. In the case of an electric vehicle, the High Voltage (HV) battery housing is generally located below the floor panel 3.

A dash panel assembly 1 is a structural part delimiting the passenger compartment 101 at its lower front end and separating it from said front motor compartment 102. The dash panel assembly 1 is also known as the firewall or the cowl. It extends in a generally longitudinal and elevation direction between the floor panel 3 and the windshield. It is also possible to have intermediate parts between the dash panel assembly 1 and the windshield, such as for example a cowl upper 4, as represented on FIG. 2. Said cowl upper can for example be dedicated to supporting the windshield and/or the hood hinges. In any case, said cowl upper does not play a major structural part in the vehicle and in particular does not play a role in the case of a front impact in which the elements located inside the front motor compartment are thrust backwards and impact the dash panel.

The dash panel assembly 1 occupies the full transversal space of the vehicle between the right and left side sills 6 and between a right and left lower A-pillar 2, as shown on FIG. 2. It is generally attached to the following elements of the body:
in front to the right and left front members 5 and to the right and left upper fender rails 7,
on the sides to the right and left side sills 6 and to the right and left lower A-pillars 2,
towards the rear of the vehicle to the floor panel 3, a tunnel nose 8 (which can be absent in the case of a purely electric driven vehicle), and to floor reinforcement members, which are attached to the floor panel 3.

It should be noted that the above list of connecting parts is not limitative and not necessarily comprehensive, because it depends on the chosen design of the vehicle architecture. The present invention deals specifically with the dash panel assembly 1 and can be applied to dash panel assemblies connected to different types of surrounding parts. What is in any case important is that the dash panel assembly 1 occupies a central location in the front load path of the vehicle, picking up important efforts from the front crash management structure, such as for example the front members 5 and the upper fender rails 7. It also occupies a central location in the front transversal load path, in between for example the front part of the side sills 6 and a large portion of the front part of the lower A pillars 2. As such, the dash panel assembly is a fundamental component of the vehicle front and side crash management system, involved in absorbing, transmitting and distributing the crash energy. It is also an important anti-intrusion part, as it sits in between the trajectory of the front motor, in case of a front impact, and the front occupants of the vehicle. If no motor is located in the front motor compartment 102, it sits directly in between the passenger compartment and the element impacting the vehicle.

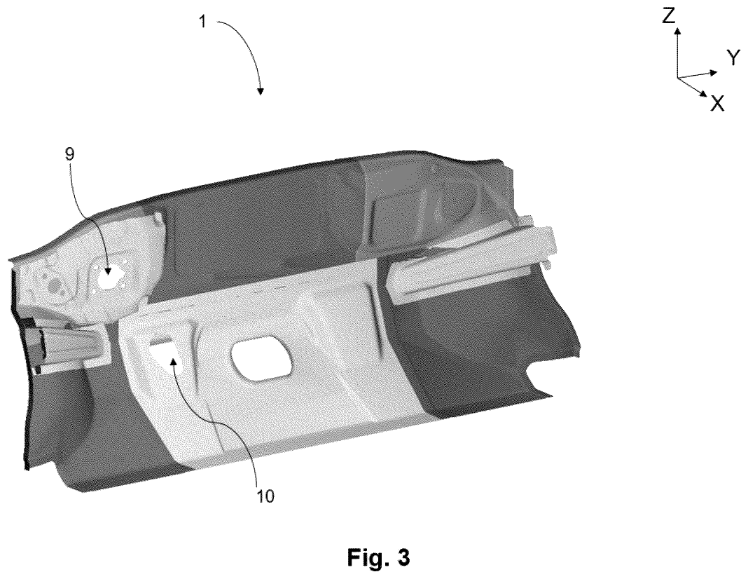

Referring to FIG. 3, which is a dash panel assembly 1 according to the state of the art, the dash panel assembly typically has a generally curved shape, the upper part being located further in front of the vehicle than the lower part. It also usually has several openings communicating with the front motor compartment, such as for example an opening 9, through which the pedal mechanism is inserted, or an opening 10 through which the steering column is inserted.

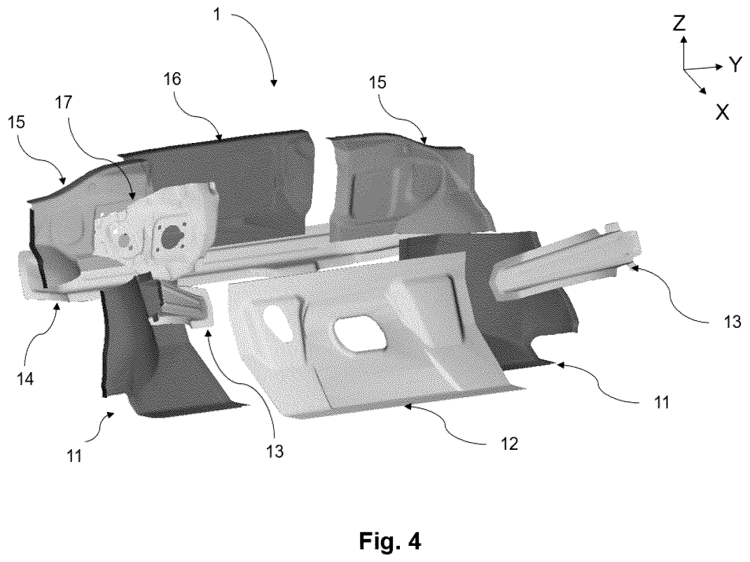

Referring to FIG. 4, which is an exploded view of a dash panel assembly according to the state of the art, the dash panel assembly according to the state of the art is made of numerous individual parts which are assembled together, for example by spot welding. In the example of FIGS. 3 and 4, ten individual parts make up the dash panel assembly:
a right and left lower side part 11,
a lower central part 12,
a right and left side bracket 13,
a reinforcement transverse beam 14,
a right and left upper side part 15,
an upper central part 16, and
an upper right reinforcement part 17.

In the case of a front impact, the front motor will be pushed backward towards the passenger compartment and the reinforcement transverse beam 14 plays an important role in resisting intrusion. The reinforcement transverse beam 14 generally has an omega shape and constitutes, when assembled with the rest of the sub parts, a hollow body extending in a transverse direction, which efficiently resists intrusion. The right and left side brackets 13 also form hollow bodies on the side of the dash panel assembly, which constitute further resistance to intrusion, especially in the case of impacts with a small overlap in the width direction, which essentially focus their energy on one side only of the dash panel assembly. Furthermore, the side brackets 13 form a robust assembly with the lower A pillar and help improve the crash resistance of the vehicle when submitted to a side impact.

The upper right reinforcement part 17 serves to provide additional stiffness in the area supporting the pedal mechanism.

The previously described dash panel assembly design comprises a large number of individual sub parts, which leads to a complex logistic and manufacturing chain. It also represents high costs in terms of tooling for forming the individual parts and in terms of assembling to join them all together. Furthermore, because the parts are joined together, for example by spot welding, they can possibly be teared apart from one another in the case of an important stress, such as the stress caused by an impact or simple repetitive fatigue stresses during the life of a vehicle. The presence of numerous sub parts is thus also the source of potential structural weaknesses.

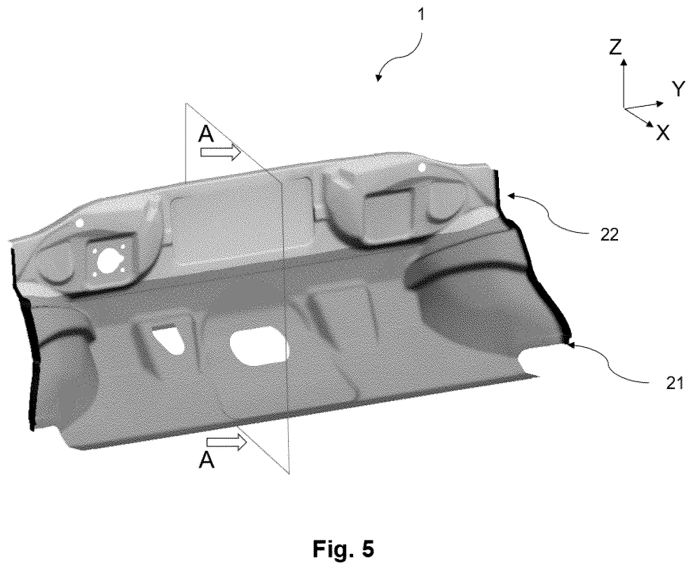

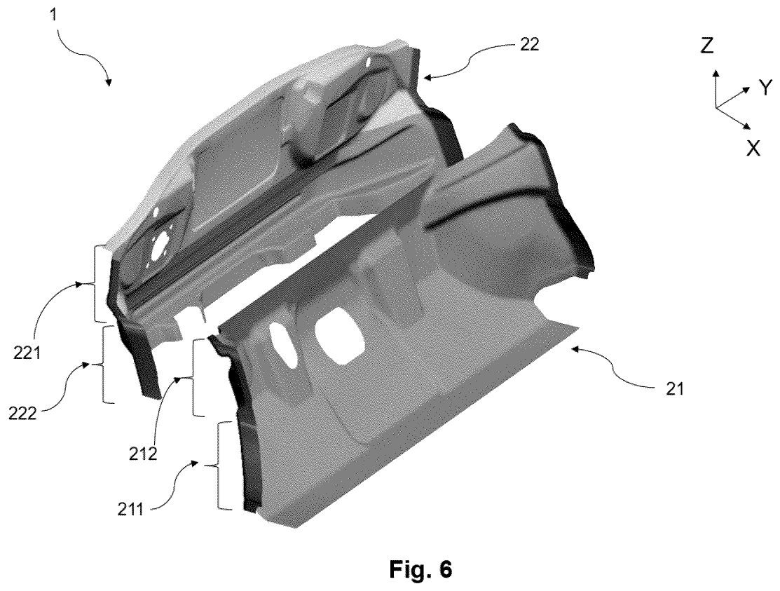

Referring to FIGS. 5 and 6, the dash panel assembly according to the current invention comprises in comparison only 2 parts, a lower dash panel 21 and an upper dash panel 22. The lower and upper dash panel 21, 22 are each made by forming a single metal sheet. For example, at least one of them is manufactured by hot stamping a single metal sheet. For example, at least one of them is manufactured by hot stamping using a multistep process a single metal sheet. For example, at least one of them is manufactured by stamping a tailor welded blank. For example, at least one of them is manufactured by stamping a tailor rolled blank.

Referring to FIG. 6, the dash panel lower 21 comprises a lower portion 211 and an overlap portion 212 located in the upper part of the dash panel lower 21. The dash panel upper 22 comprises an upper portion 221 and an overlap portion 222 located in the lower part of the dash panel upper 22. Once assembled, the dash panel lower and upper overlap portions 212 and 222 are superimposed on to one another (hence the term overlap). The portion of the dash panel assembly 1 in which the dash panel lower and upper overlap each other is termed the overlap portion 12. On the other hand, once the dash panel is assembled, the lower portion of the dash panel lower 211 and the upper portion of the dash panel upper 221 do not overlap each other.

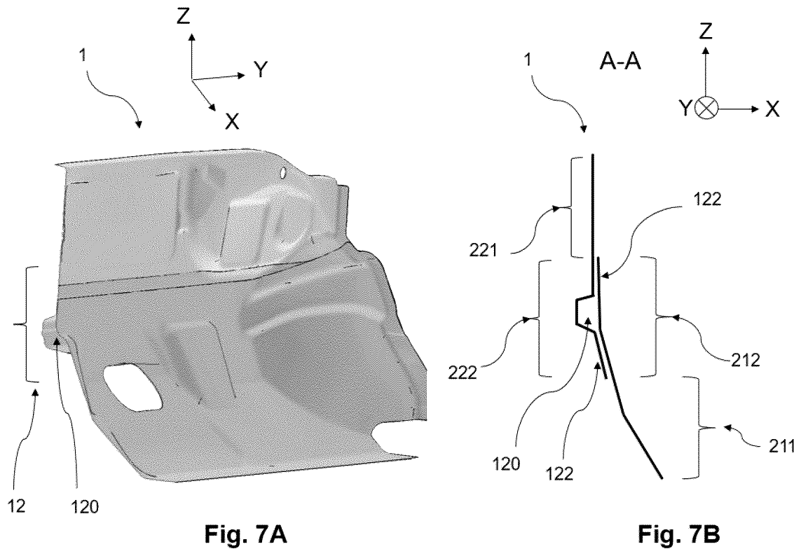

Referring to FIG. 7B, which is a schematic cross section of the dash panel assembly 1 according to the invention, the overlap portion 12 comprises at least one flat overlap area 122, in which the upper and lower dash panels 21 and 22 lay flat onto each other. In other words, in the at least one flat overlap area 122 of the overlap portion 12, the dash panel lower overlap portion 212 and the dash panel upper overlap portion 222 have the same shape so that once assembled they fit flat onto one another in said flat overlap area 122. It is possible to assemble the upper and lower dash panel 22, 21 together in the at least one flat overlap area 122, for example by resistance spot welding or by laser welding. The flat overlap area 122 further offers the technical advantage of having a greatly increased resistance against intrusion because two layers of formed sheet metal are available in this area to resist intrusion conjointly.

In a particular embodiment, as depicted on FIGS. 7A and 7B, the overlap area 12 further comprises at least one hollow portion 120 in which the overlap portions of the upper and lower dash panels 212 and 222 are spaced away from one another in the longitudinal direction in order to define together an inner volume comprised in between said overlap portions 212 and 222. Advantageously, the presence of a hollow portion 120 allows to increase the overall stiffness of the dash panel assembly 1 and also allows to better resist intrusion. Indeed, the presence of a hollow portion 120 imparts rigidity to the dash panel assembly and makes it more difficult to deform in said hollow portion.

In the attached figures, the hollow portion 120 is formed by designing substantially horizontal walls in the dash panel upper overlap portion 212 over the entire width of the part and also by designing substantially horizontal walls in the side sections of the dash panel lower overlap portion 222. The central portion of the dash panel lower overlap portion 222 is kept substantially flat in the hollow portion 120, acting as a flat closing plate of the inner volume. Advantageously, this design allows to create larger hollow volumes in the sides of the dash panel assembly, allowing to resist further intrusion on the sides. This is particularly useful in the case of a front impact with a small overlap during which the load will mainly be applied on one side only of the part.

It is possible to design the hollow portion 120 in different ways, for example by using rounded bead-like shapes in the corresponding dash panel lower and/or upper overlap portion 222, 212.

Generally speaking, the amount of absorbed crash energy and of anti-intrusion resistance will be greater if the horizontal walls are designed in the sheet metal having the greatest mechanical resistance. For example, the amount of absorbed crash energy and of anti-intrusion resistance will be greater if the horizontal walls are designed in the sheet metal having the greatest sheet metal thickness, or having the greatest yield strength, or having the greatest product of yield strength by sheet metal thickness.

The design of the current invention allows to greatly simplify the conception and the manufacturing process of the dash panel assembly by reducing the number of sub-parts. In turn it allows to greatly reduce the number of assembly points between the sup-parts.

The reduction of the number of overlapping regions necessary to assemble the different sub parts, associated with an optimal choice of materials, also leads to a significant weight reduction of the assembly.

Furthermore, the inventive design reproduces in a simplified way the key safety features of the state-of-the-art design, and in particular the reinforcement of the dash panel assembly in its central portion. Said reinforcement is ensured for example by a reinforcement transverse beam 14 in the state-of-the-art design. In the inventive design, said reinforcement is ensured by the doubling up of sheet thickness in the overlap portion 12, optionally enhanced by the presence of a hollow portion 120 in the overlap portion 12. The overlap portion 12 of the inventive design allows to prevent the front motor from penetrating the passenger compartment 101. It also allows to increase the overall stiffness of the part and to resist to transverse compressive load exerted on the part in the case of a side impact.

In a specific embodiment the dash panel assembly is made by hot stamping steel sheets and the blanks used to produce the dash panel assembly comprise one of the following materials, either in the form of monolithic blanks or combined in the form of tailor welded blanks:

Steel having a composition comprising in % weight: 0.06%≤C≤0.1%, 1%≤Mn≤2%, Si≤0.5%, Al≤0.1%, 0.02%≤Cr≤0.1%, 0.02%≤Nb≤0.1%, 0.0003%≤B≤0.01%, N≤0.01%, S≤0.003%, P≤0.020% less than 0.1% of Cu, Ni and Mo, the remainder being iron and unavoidable impurities resulting from the elaboration. With this composition range, the yield strength of the corresponding area after hot stamping is comprised between 700 and 950 MPa, the tensile strength between 950 MPa and 1200 MPa and the bending angle is above 75°. For example, this material is used in the area corresponding to the upper portion 221 of the upper dash panel, because it absorbs energy without cracking and this area does not need to resist intrusion as much as the upper dash panel overlap portion 222.

Steel having an ultimate tensile strength after hot stamping which is comprised between 1300 MPa and 1650 MPa and a yield strength which is comprised between 950 MPa and 1250 MPa.

Steel having an ultimate tensile strength after hot stamping which is comprised between 1300 MPa and 1650 MPa, a yield strength which is comprised between 950 MPa and 1250 MPa and a bending angle which is above 75°.

Steel having a composition comprising in % weight: 0.20%≤C≤0.25%, 1.1%≤Mn≤1.4%, 0.15%≤Si≤0.35%, Cr≤0.30%, 0.020%≤Ti≤0.060%, 0.020%≤Al≤0.060%, S≤0.005%, P≤0.025%, 0.002%≤B≤0.004%, the remainder being iron and unavoidable impurities resulting from the elaboration. With this composition range, the ultimate tensile strength of the corresponding area of the part after hot stamping is comprised between 1300 MPa and 1650 MPa and the yield strength is comprised between 950 MPa and 1250 MPa. For example, this steel composition is used for the areas corresponding to the overlap portion 12 of the dash panel assembly (i.e. for the steel making up the overlap portions 212, 222 of the dash panel lower and upper). Indeed, this steel grade has high anti-intrusion properties.

Steel having a tensile strength after press-hardening higher than 1800 MPa.

Steel having a composition which comprises in % weight: 0.24%≤C≤0.38%, 0.40%≤Mn≤3%, 0.10%≤Si≤0.70%, 0.015%≤Al≤0.070%, Cr≤2%, 0.25%≤Ni≤2%, 0.015%≤Ti≤0.10%, Nb≤0.060%, 0.0005%≤B≤0.0040%, 0.003%≤N≤0.010%, S≤0,005%, P≤0,025%, %, the remainder being iron and unavoidable impurities resulting from the elaboration. With this composition range, the tensile strength of the corresponding area of the dash panel assembly after hot stamping is higher than 1800 MPa. For example, this material is used in the overlap portion 12, to benefit from its high anti-intrusion properties.

Steel having a composition which comprises in % weight: C: 0.15-0.25%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Mo≤0.40%, Nb≤0.08%, Ca≤0.1%, the remainder of the composition being iron and unavoidable impurities resulting from the smelting. With this composition range, the tensile strength of the corresponding area of the dash panel assembly after hot stamping is higher than 1350 MPa and the bending angle is higher than 70°.

Steel having a composition which comprises in % weight: C: 0.26-0.40%, Mn: 0.5-1.8%, Si: 0.1-1.25%, Al: 0.01-0.1%, Cr: 0.1-1.0%, Ti: 0.01-0.1%, B: 0.001-0.004%, P≤0.020%, S≤0.010%, N≤0.010% and comprising optionally one or more of the following elements, by weight percent: Ni≤0.5%, Mo≤0.40%, Nb≤0.08%, Ca≤0.1% the remainder of the composition being iron and unavoidable impurities resulting from the smelting. With this composition range, the tensile strength of the corresponding area of the dash panel assembly after hot stamping is higher than 1350 MPa and the bending angle is higher than 70°.

Steel having a composition which comprises in % weight: C: 0.2-0.34%, Mn: 0.50-1.24%, Si: 0.5-2%, P≤0.020%, S≤0.010%, N≤0.010%, and comprising optionally one or more of the following elements, by weight percent: Al: ≤0.2%, Cr≤0.8%, Nb≤0.06%, Ti≤0.06%, B≤0.005%, Mo≤0.35%, the remainder of the composition being iron and unavoidable impurities resulting from the smelting. With this composition range, the tensile strength of the corresponding area of the dash panel assembly after hot stamping is equal to or higher than 1000 MPa and the bending angle is higher than 55°.

Steel having a composition which comprises in % weight: C: 0.13-0.4%, Mn: 0.4-4.2%, Si: 0.1-2.5%, Cr≤2%, Mo≤0.65%, Nb≤0.1%, Al≤3.0%, Ti≤0.1%, B≤0.005%, P≤0.025%, S≤0.01%, N≤0.01%, Ni≤2.0%, Ca≤0.1%, W≤0.30%, V≤0.1%, Cu≤0.2%, and verifying the following combination: 114−68*C−18*Mn+20*Si−56*Cr−60*Ni−36*Al+38*Mo+79*Nb−17691*B<20, the remainder of the composition being iron and unavoidable impurities resulting from the smelting. For example, this composition is used when hot stamping the part using a multistep process.

Steel which is coated with an aluminum-based metallic coating. By aluminum based it is meant a coating that comprises at least 50% of aluminum in weight. For example, the metallic coating is an aluminum-based coating comprising 8-12% in weight of Si. For example, the metallic coating is applied by dipping the base material in a molten metallic bath. Advantageously, applying an aluminum-based metallic coating avoids the formation of surface scale during the heating step of the hot stamping process, which in turn allows to produce the parts by hot stamping without a subsequent sand blasting operation. Furthermore, the aluminum-based coating also provides corrosion protection to the part while in service on the vehicle.

Steel which is coated with an aluminum-based metallic coating comprising from 2.0 to 24.0% by weight of zinc, from 1.1 to 12.0% by weight of silicon, optionally from 0 to 8.0% by weight of magnesium, and optionally additional elements chosen from Pb, Ni, Zr, or Hf, the content by weight of each additional element being inferior to 0.3% by weight, the balance being aluminum and optionally unavoidable impurities. Advantageously, this type of metallic coating affords very good corrosion protection on the part, as well as a good surface aspect after hot stamping.

In a specific embodiment, at least the upper or lower dash panel is made by hot stamping a laser welded blank comprising at least one sub blank having an aluminum based metallic coating and said aluminum coated sub-blanks are prepared before hand by ablating at least part of the metallic coating on the edges to be welded. Advantageously, this removes part of the aluminum present in the coating, which would pollute the weld seam and deteriorate its mechanical properties.

In a particular embodiment, at least one of the upper or lower dash panels is made by hot stamping a laser welded blank comprising at least one sub blank having at least one side topped with an emissivity increasing top layer. Said emissivity increasing top layer is applied on the outermost surface of said sub-blank. Said emissivity increasing top layer allows the surface of said sub blank to have a higher emissivity compared to the same sub-blank which is not coated with said emissivity increasing top layer. Said emissivity increasing top layer can be applied either on the top or the bottom side of a sub-blank. Said emissivity increasing top layer can also be applied on both sides of said sub-blank. If said sub-blank comprises a metallic coating, such as described previously, the emissivity increasing top layer is applied on top of said metallic coating. Indeed, for the emissivity increasing top layer to increase the emissivity of the surface, it needs to cover the outermost surface of the sub-blank. Advantageously, said emissivity increasing top layer will allow to increase the heating rate of said sub-blank and therefore increase the productivity of the heating step of the hot stamping process. When using several sub blanks of differing thicknesses, said emissivity increasing top layer is advantageously applied to the sub-blanks having the highest thickness in order to decrease the difference in heating time between the different sub-blanks and therefore increase productivity, increase the hot stamping process window and overall allow to obtain a final part having homogeneous surface properties.

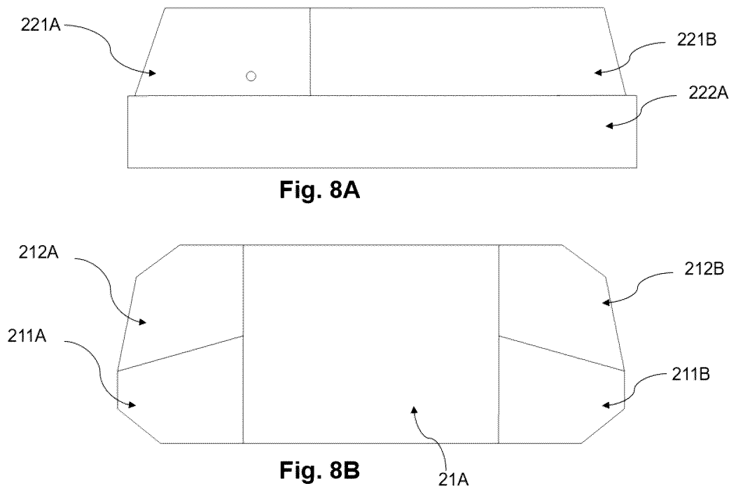

In a particular embodiment, the upper and lower dash panel is made by hot stamping the tailor welded blanks schematically represented respectively on FIGS. 8A and 8B. The steel grades and thicknesses will be further detailed by referring to the following table (which can be produced using the above detailed embodiments for steel grades chemistry):

| Steel | Yield strength | Tensile Strength | |
|---|---|---|---|
| reference | (MPa) | (MPa) | Bending angle |
| D1000 | 700-950 | 950-1200 | At least 70° |
| U1500 | 1300-1650 | 950-1250 | — |

The steel D1000 has a lower yield strength but a high bending angle. It will therefore deform and absorb energy more easily than the steel U1500. On the other hand, the steel U1500 will have better anti-intrusion behavior than D1000 thanks to its higher strength.

Referring to FIG. 8A, the tailor welded blank used for the upper dash panel 22 consists of three sub-blanks 221A, 221B and 222A having the following grade and thickness:

| Sub blank | Steel | |
|---|---|---|
| reference | grade | thickness |
| 221A | D1000 | 1.4 mm |
| 221B | D1000 | 1.0 mm |
| 222A | U1500 | 2.5 mm |

Sub-blanks 221A and 221B correspond to the upper portion 221 of the upper dash panel upper once the part is formed. On the other hand, sub-blank 222A corresponds to the overlap portion 222 of the dash panel upper once the part is formed.

As was previously explained, the anti-intrusion function of the dash panel assembly is mainly ensured by the overlap portion 12. Thus, sub blank 222A of the current embodiment is made of the very high strength steel grade D1500 and with a high thickness of 2.5 mm. Moreover, in the case of the current embodiment, once formed, the overlap portion 222 of the upper dash panel comprises substantially horizontal walls in order to form a hollow portion 120 within the overlap portion 12. Choosing a very high strength, high thickness material in this section, as is the case in the current embodiment, will advantageously increase the rigidity and anti-intrusion behavior of the part.

On the other hand, the upper portion of the upper dash panel is allowed to deform without cracking during a front impact in order to absorb energy. The steel grade D1000 was therefore chosen for sub-blanks 221A and 221B. Furthermore, because 221A is located in the area in which the pedal mechanism is inserted, a higher thickness was chosen for this sub-blank to increase the rigidity in this area.

Because sub blank 222A has a significantly higher thickness than the other sub blanks, it will be interesting to provide sub blank 222A with the above-described emissivity increasing top layer on at least one side in order to ensure that the heating speed in the austenitizing furnace of all the areas of the tailor welded blank is as homogeneous as possible.

Turning to the lower dash panel 21, the tailor welded blank consists of four sub-blanks 212A, 212B, 211A, 211B and 21A having the following grade and thickness:

| Sub blank | Steel | |
|---|---|---|
| reference | grade | thickness |
| 212A | U1500 | 1.6 mm |
| 212B | U1500 | 1.6 mm |
| 211A | U1500 | 1.5 mm |
| 211B | U1500 | 1.5 mm |
| 21A | U1500 | 1.2 mm |

Sub-blanks 212A and 212B correspond to the overlap portion 212 of the lower dash panel upper once the part is formed. On the other hand, sub-blanks 211A and 211B correspond to the lower portion 211 of the dash panel lower once the part is formed. Sub blank 21A spans both the overlap portion and the lower portion once the part is formed.

As can be seen, the material thickness is higher on the sub blanks occupying the sides of the part (212A, 212B, 211A, 211B) than on the sub-blank occupying the center of the part (21A). This is to provide better resistance of the part in the case of a partial overlap crash such as the ones simulated by the above detailed ODB or SORB regulatory tests. Furthermore, the blanks 212A, 212B corresponding to the sides of the overlap portion have a higher thickness than the ones corresponding to the lower portion because of the necessity to have a higher anti-intrusion resistance in the overlap portion.

The above-described embodiment allows to greatly reduce the number of spot welds to assemble the dash panel. For example, it allows to reduce the number of spot welds from 158 spot welds in the presented state of the art assembly (see FIGS. 3 and 4) down to 80 spot welds in the current embodiment of the invention (FIGS. 5 and 6).

It also allows for an overall weight reduction: the state-of-the-art assembly weighs 18.70 kg, while the inventive design weighs 17.34 kg, a significant 7% weight reduction.

The inventors have found that it was possible to reach the same safety performance in the above cited IIHS ODB and SORB crash tests between the above cited 18.70 kg state of the art design and the 17.34 kg inventive design. This shows that the inventive design allows to reach a better compromise between safety performance and weight of the part than the state of the art.

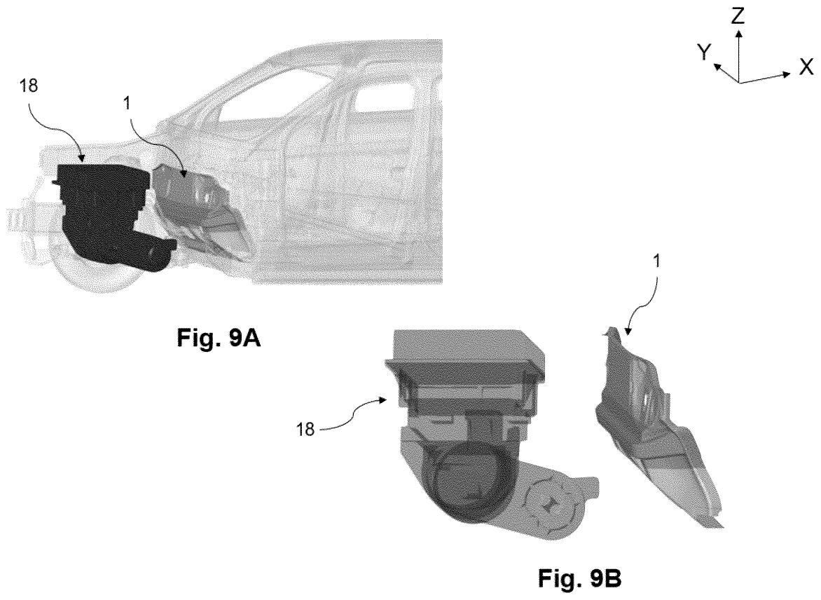

FIGS. 9A, B to 11A,B represent a simulated IIHS's front overlap deformable barrier (ODB) crash test involving the above detailed specific embodiment of the invention. In this test, the vehicle is impacted with only 40% overlap in the width by a rigid barrier moving at 64.4 km/h.

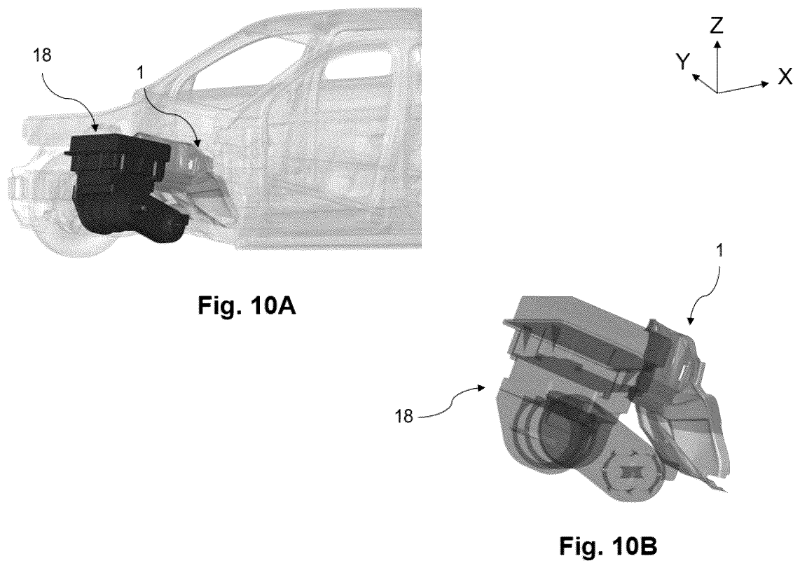

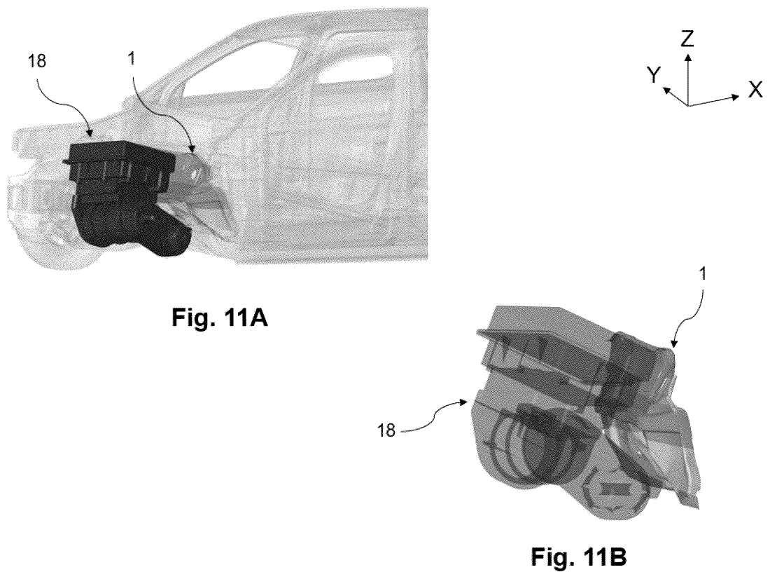

At the start of the test, just before the barrier impacts the vehicle (FIGS. 9A and 9B), the motor 18 is located at a distance from the dash panel assembly 1. Once the impactor hits the vehicle, it pushes the motor 18 backwards towards the vehicle compartment, eventually hitting the dash panel assembly 1 at t=0.085 s (FIGS. 10A, 10B). The crash also has the effect of tilting the motor 18 at an angle, as can be seen on the figures. At t=0.105 s the impactor reaches its maximum penetration depth (FIGS. 11A and 11B). The simulation shows that the dash panel assembly resists intrusion of the motor into the passenger compartment, thanks in particular to the overlap portion 12. The upper and lower dash panel does cave in under the pressure applied by the motor but there is no significant intrusion and the overlap portion 12 stays rigid.

What is claimed is:

1-5. (canceled)

6: A dash panel assembly for an automotive vehicle occupying the full transversal space of the automotive vehicle in between a right and left side sill and in between right and left lower A-pillars, the dash panel assembly separating a front motor compartment from a passenger compartment, the dash panel assembly comprising:
a lower dash panel and an upper dash panel,
the lower and upper dash panels each made by forming a single metallic sheet,
the lower dash panel including a lower portion and a lower dash panel overlap portion,
the upper dash panel including an upper portion and an upper dash panel overlap portion,
once assembled to form the dash panel assembly, the dash panel lower portion and the upper overlap portion overlap each other to define an overlap portion and the lower portion and the upper portion do not overlap each other;
the overlap portion including at least one flat overlap portion where the lower and upper dash panels lay flat onto each other.

7: The dash panel assembly for the automotive vehicle according to claim 6 wherein at least one of the lower and upper dash panels is made by stamping a tailor welded blank.

8: The dash panel assembly for the automotive vehicle according to claim 7 wherein at least one of the lower and upper dash panels is made by hot stamping.

9: The dash panel assembly for the automotive vehicle according to claim 6 wherein the overlap portion further includes a hollow portion where the lower and upper dash panel overlap portions are spaced from one another in a longitudinal direction to form a hollow volume between them.

10: A method for manufacturing an automotive vehicle comprising employing the dash panel assembly as recited in claim 6.
